(19) United States
(12) Patent Application Publication
(10) Pub. No.: US 2013/0038437 A1
(43) Pub. Date: Feb. 14, 2013

(54) SYSTEM FOR TASK AND NOTIFICATION HANDLING IN A CONNECTED CAR

(71) Applicants: Rohit Talati, Santa Clara, CA (US); Junnosuke Kurihara, Milpitas, CA (US); David Kryze, Campbell, CA (US); Jae Jung, Cupertino, CA (US)

(72) Inventors: Rohit Talati, Santa Clara, CA (US); Junnosuke Kurihara, Milpitas, CA (US); David Kryze, Campbell, CA (US); Jae Jung, Cupertino, CA (US)

(73) Assignee: PANASONIC CORPORATION, Osaka (JP)

(21) Appl. No.: 13/205,076

(22) Filed: Aug. 8, 2011

(51) Int. Cl. B60Q 1/00

(52) U.S. Cl. 340/438

(57) ABSTRACT

The vehicular notification and control apparatus receives user input via a multimodal control system, optionally including touch-responsive control and non-contact gestural and speech control. A processor-controlled display provides visual notifications of notifications and tasks according to a dynamically prioritized queue which takes into account environmental conditions and driving context and available driver attention. The display is filtered to present only valid notifications and tasks for the current available driver attention level. Driver attention is determined using multiple, diverse sensors integrated through a sensor fusion mechanism.

### FIELD

The present invention relates generally to vehicular notification and control systems. More particularly, the invention relates to an apparatus and method to present incoming tasks and notifications to the operator of a vehicle in such a way that the operator's attention is not compromised while driving.

### BACKGROUND

Although much work has been done in designing human-machine interfaces for displaying information and controlling functions within a vehicle, until recently, the task has been limited to stand-alone systems that principally provide information generated by the vehicle or within the vehicle. Designing a human-machine interface in such cases is a relatively constrained task because the systems being controlled and the information generated by those systems is relatively limited and well understood. For example, to interact with an FM radio or music player, the required functionality can readily anticipated (e.g., on/off, volume up, volume down, skip to next song, skip to next channel, etc.). Because the functionality is constrained and well understood, human-machine user interface designers can readily craft a human-machine interface that is easy to use and free from distraction.

However, once internet connectivity is included in the vehicular infotainment system, the human-machine interface problem becomes geometrically more complex. This is, in part, due to the fact that the internet delivers a rich source of different information and entertainment products and resources, all which may have their own user interface features. A concern for interface designers is that this plethora of different user interfaces features may simply be too complex and distracting in the vehicular environment.

One solution to the problem might be to attempt to unify the user interface across all different internet offerings, but such solution is problematic in at least two respects. First, it may simply not be feasible to create such a unifying interface because individual internet offerings are constantly changing and new offerings are constantly being added. Second, users become familiar with the interface of a particular internet application or service, and prefer to have that same experience when they interact with the application or service within their vehicle.

### SUMMARY

The notification and control apparatus and method of the present disclosure takes a different approach. It receives and stores incoming notifications and tasks or notifications and places them in a dynamically prioritized queue. The queue is dynamically sorted based on a variety of different environmental and driving condition factors. The systems processor draws upon that queue to present visual notifications to the driver upon a connected display, where the visual notifications are presented in a display order based on the prioritized queue. A plurality of sensors each respond to different environmental conditions or driving contexts, and these sensors are coupled to a sensor fusion mechanism administered by the processor to produce a driver attention metric. Based on the sensor data, the driver attention metric might indicate, for example, that the driver has a high level of available attention when the vehicle is parked. Conversely, the driver attention metric might indicate that the driver has no available attention when the vehicle is being operated in highly congested traffic during a heavy rainstorm. The processor is programmed to supply visual notifications to the display in a manner regulated by the driver attention metric. Thus, when driver attention is limited, certain notifications and associated functionality is deferred or suppressed. When available driver attention rises, these deferred or suppressed notifications and operations are displayed as being available for selection.

Interaction with the notification and control apparatus may be provided through a control mechanism that offers multimodal interactive capability. In one presently preferred form, the control mechanism allows the driver to interact with the various notifications being displayed through a variety of different redundant interaction mechanisms. These include vehicle console, dashboard and steering wheel mounted buttons, touchpad surfaces to receive gestural commands, noncontact gesture control mechanisms that sense in-air gestures and voice-activated systems and speech recognition systems.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates the display component of the vehicular notification and control apparatus in one exemplary vehicular embodiment;

FIG. 2 is a hardware block diagram of the notification and control apparatus;

FIG. 3 is a data flow diagram of the notification and control system;

FIG. 4 is a process flow diagram of the system of FIG. 3;

FIG. 5 is a block diagram illustrating how the driver attention metric is used by the notification manager in handling the dynamically prioritized queue;

FIG. 6 is a block diagram illustrating feature extraction and sensor fusion used to generate the real time driver attention level metric;

FIG. 7 is a flow chart diagram illustrating how driver attention level metric is attained;

FIG. 8 is a flow chart diagram illustrating how notifications are prioritized and presented;

FIGS. 9a, 9b and 9c are user interface diagrams illustrating different examples of the notification bar of the display generated by the notification and control apparatus.

Corresponding reference numerals indicate corresponding parts throughout the several views of the drawings. Example embodiments will now be described more fully with reference to the accompanying drawings.

### DESCRIPTION OF THE PREFERRED EMBODIMENTS

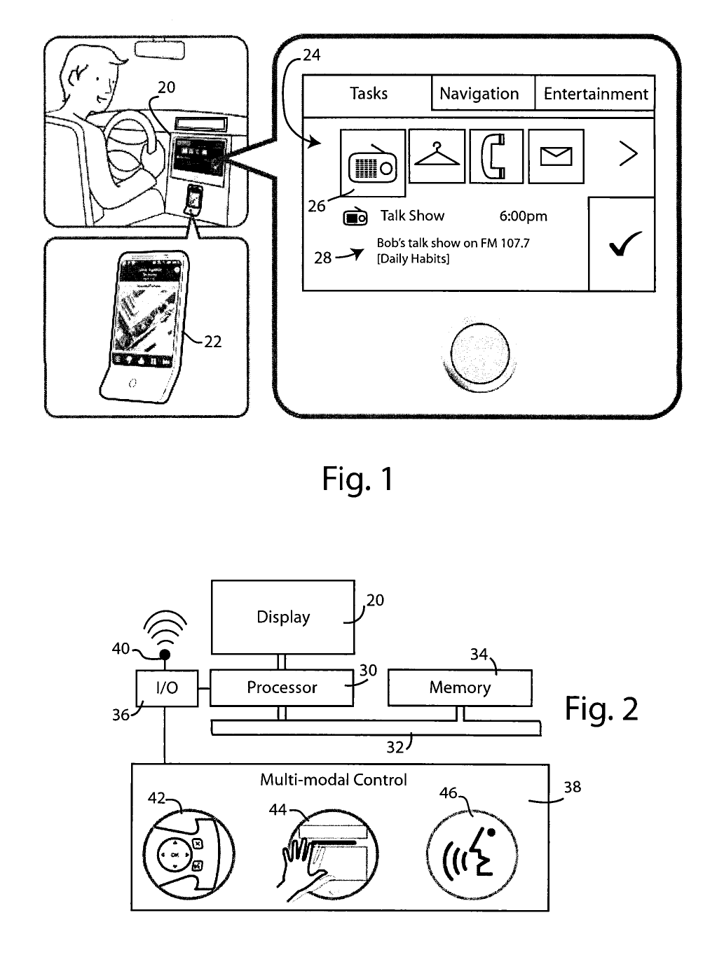

The vehicular notification and control apparatus may be manufactured into or retrofit into a vehicle, or otherwise suitably packaged for use within a vehicle. FIG. 1 depicts an embodiment where the vehicle notification and control apparatus is manufactured into the vehicle and integrated with the display 20 of the vehicle infotainment system or navigation system. In the embodiment shown in FIG. 1, cellular connectivity is provided by Bluetooth or other suitable connection with a cellular phone 22 that provides access to internet content. In this regard, it will be understood that use of separate cell phone to supply internet content is merely one example. Depending on the system requirements, internet connectivity may be supplied via other mechanisms, such as on-board cellular modem, OnStar , WiFi receiver and other wireless internet connectivity solutions.

FIG. 1 shows that the display 20 provides, in accordance with the teachings of this disclosure, a user-manipulable graphical display that includes a generally horizontally disposed notification bar which presents various incoming notifications and tasks in a prioritized order when scanned from left to right. In this particular illustration, the highest priority notification corresponds to an entertainment (radio) notification, designated by graphical icon 26. Additional information about the notification is shown both graphically and texturally in the region 28 beneath the notification bar. As will be more fully explained below, the vehicular notification and control apparatus establishes the order and user interaction capabilities of the notification bar based on a prioritized queue and further regulated by a driver attention metric.

Illustrated in FIG. 2, one presently preferred hardware embodiment of the notification and control apparatus employs a processor 30 that is coupled through a computer bus structure 32 to a random access memory device 34. The memory device serves two functions. It holds the program operating instructions used by processor 30 to perform the functions described herein. It also stores real time data values and static content used to implement the prioritized queue and used to generate the content portrayed on display 20. Attached to processor 30 is an input/output (I/O) circuit 36. This circuit couples the processor to a multi-modal control system 38 and also to a wireless communication system 40. The multi-modal control system 38 provides a disparate set of redundant user-manipulable controls that include, without limitation, touch-responsive controls, such as a steering wheel-mounted push button array 42, and non-contract controls, such as non-contact gesture controlled system 44 and voice/speech recognizer controls 46.

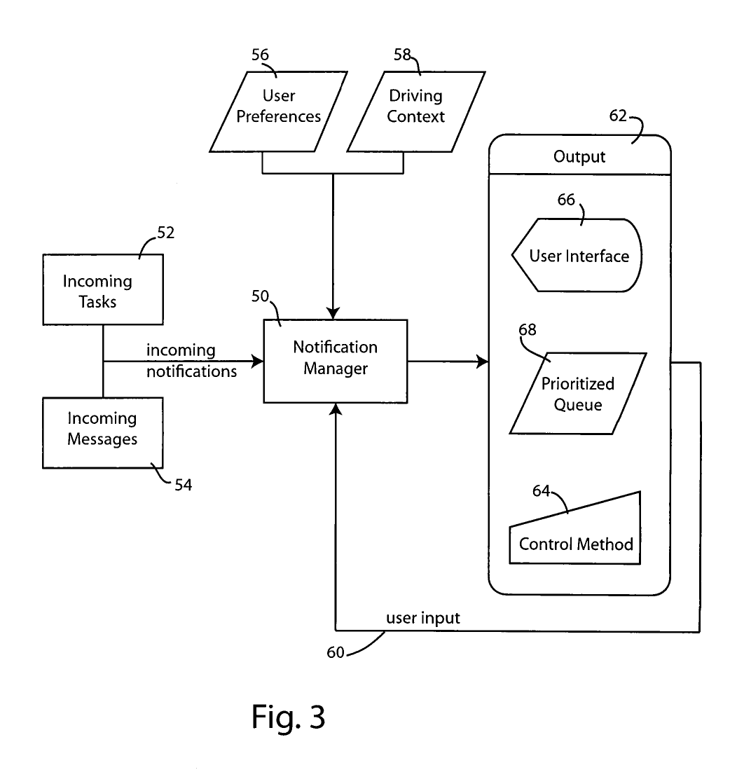

As depicted in FIG. 3, the processor 30 is programmed to implement a notification manager, shown diagrammatically at 50. The notification manager 50 is principally involved in harvesting, processing and presenting incoming tasks and notifications for display, acting as a software agent that intelligently acts on the driver's behalf based on driving conditions and driver's current state of mind. The notification manager 50 operates upon notification data collected from a variety of sources, including incoming tasks 52 and incoming messages 54. As used herein, incoming tasks correspond to notifications that are scheduled in advance, such as calendared appointments, entertainment programs, such as podcasts, and other predetermined notifications. Incoming messages correspond to spontaneous notifications which the system learns about by telecommunication such as via cell phone or internet push services. Collectively, incoming tasks and incoming messages are referred to herein as incoming notifications or notification data.

Notification manager 50 also receives additional input as user preferences 56 and as driving context information 58. User preferences are obtained either by direct user input via the system user interface or through adaptive/learning algorithms. Driving context corresponds to a collection of disparate data sources by which the system learns and calculates metrics regarding the real time or instantaneous driving conditions.

The notification manager also responds to user input, as depicted at 60. Such user input is derived from the multi-modal control system 38 (FIG. 2) and/or from menu selections made directly on the display 20.

The notification manager controls an associated output module 62 that, like the notification manager 50, is implemented by the processor 30 (FIG. 2). The output module 62 includes a collection of control methods 64 that are stored in the memory 34 (FIG. 2) as non-transitory program instructions by which the multi-modal control system 38 is controlled and by which data from that system are interpreted, manipulated and stored in memory 34.

The output module 62 also includes a collection of user interface methods 66, which are likewise stored in the memory 34 (FIG. 2) and used by processor 30 to generate the displays and message bar illustrated elsewhere in this document.

The output module 62 also administers and maintains a prioritized queue 68 which is implemented as a queue data structure stored in memory 34 and operated upon by the processor 30 to organize incoming tasks and incoming notifications according a predetermined set of rules. The prioritized queue is thus dynamically sorted and resorted on a real time basis by operation of processor 30. The prioritized queue is presented to the driver through the user interface, and the control methods allow the driver to perform actions such as accepting or deferring the current highest priority item. The system dynamically reacts to changes in the environment and driving context and modifies the queue and user interface accordingly.

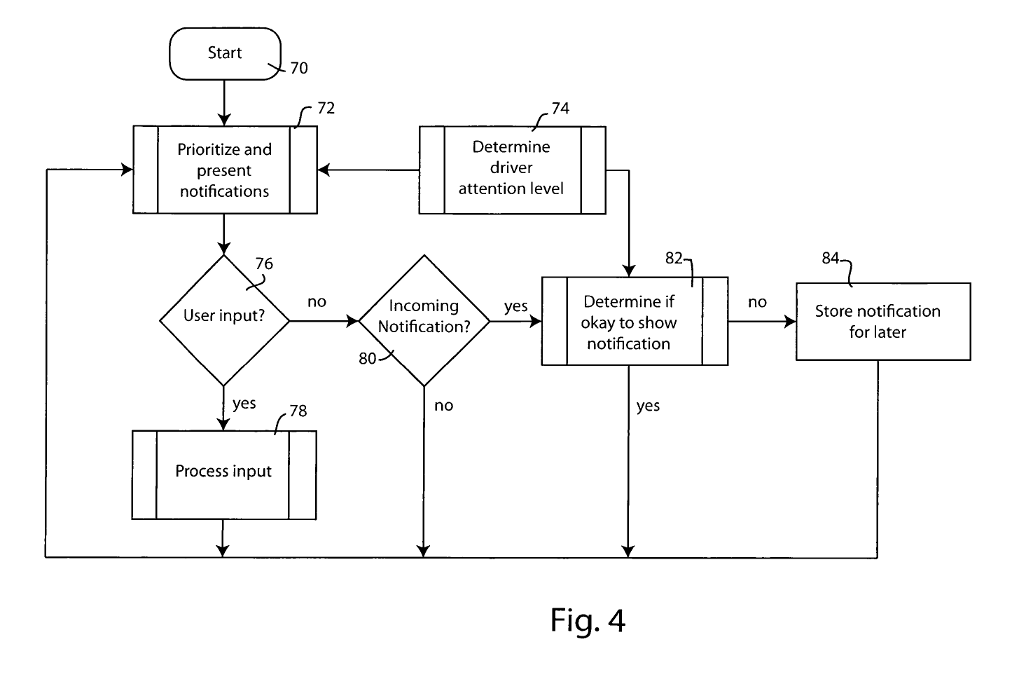

FIG. 4 gives an overview of how data flow is managed by the notification manager 50. The flow control begins at 70 where the notifications (messages and tasks) are prioritized and presented at 72. The prioritization and presentation process uses a driver attention metric that is determined by separate process at 74. That is, the driver attention metric is used to sort the prioritized queue. This sorting of the prioritized queue does not necessarily mean that every notification and task within the queue will actually be presented. The prioritization and presentation process 72 includes a sequence of sub-processes that ultimately determine whether the notification or task is presented for display at a particular time or stored for notification later. This sub-process begins at step 76 where the notification manager polls the multi-modal control system 38 (FIG. 2) to determine if there is user input. Any detected user input will then be processed at step 78. If there are no user input to process, flow control continues to step 80 where detection of incoming notifications is performed. Incoming notifications may be obtained, for example, via the input/output circuit 36 which is in turn coupled to a wireless internet connection. Incoming notifications may be stored in a buffer within memory 34 where they are held, pending processing at step 80 and subsequent steps.

If there is no unprocessed incoming notification, the process flow loops back to step 72 where the queue is again dynamically updated and notifications (and tasks) are presented for display based on the order in the queue, taking into account the current driver attention metric. If there is an unprocessed incoming notification at step 80, the notification manager determines at step 82 whether it is appropriate to show that notification. If so, the notification is tagged and the flow loops back to step 72 where that notification is added to the queue and presented for notification based on the order expressed in the queue, taking into account driver attention level. Step 82 makes the determination whether it is appropriate to show the incoming notification based on the driver attention metric determined at step 74. Thus, it will be seen that the driver attention metric serves two functions. It is a factor in how messages in the queue are prioritized for presentation (step 72) and it is also a factor in determining whether a particular notification is appropriate to show (step 82).

If the incoming notification being processed is deemed not appropriate to show at this time, it is tagged at step 84 to be stored for possible display at a future time.

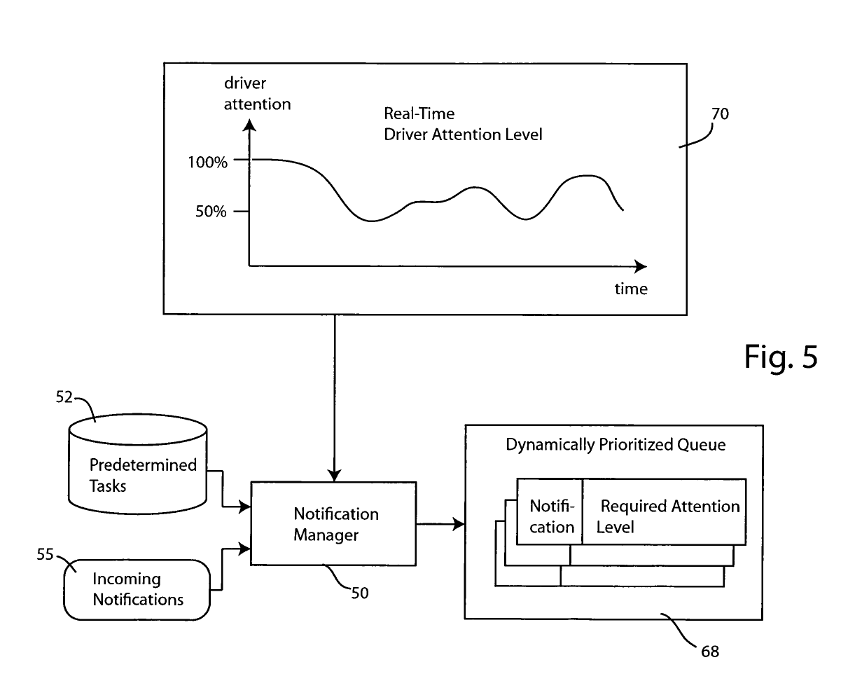

FIG. 5 shows in greater detail how the prioritize and present notifications process 72 (FIG. 4) is performed by the notification manager 50. As illustrated, predetermined tasks 52 are stored in a data structure or database within the computer memory 34 and incoming notifications 55 are stored in a buffer within computer memory 34. These two data sources are supplied to the notification manager 50, which then places them into the prioritized queue 68. The notification manager 50 dynamically resorts the queue based, in part, on the real time value of the driver attention metric. As shown graphically at 70, the driver attention metric may be normalized to correspond to a percentage value indicative of how much driver attention is available for other tasks. For example, if the vehicle is parked, the available driver attention for other tasks would be 100%. On the other hand, when the vehicle is being driven in congested traffic during a heavy rain storm, the driver attention available for other tasks would be a low percentage, perhaps 0%. The driver attention metric will, of course, fluctuate over time, as illustrated.

The notification manager 50 periodically resorts the prioritized queue, using the real time value of the driver attention metric to determine which notification and tasks are appropriate for display under the current conditions. The prioritized queue stores notification records in a queue data structure where each notification corresponds to a predetermined task or an incoming notification to which is associated a required attention level value. The required attention level value may be statically or dynamically constructed. In one embodiment, each type of notification (task or message) is assigned to a predetermined class of notifications and thus inherits the required attention level value associated with that class. Listening to the radio or to a recorded music program might be assigned to a background listening class that has a low required attention level value assigned. Reading and processing email messages or interacting with a social media site would be assigned to an interactive media class having a much higher required attention level assigned.

While statically assigned attention level values are appropriate for many applications, it is also possible to assign attention level values dynamically. This is accomplished by algorithmically modifying the static attention level values depending on the real time driver attention metric and upon the identity of notifications already in the queue. Thus, for example, when available driver attention is at a high percentage, the system may adjust required attention level values, making it possible for the user to “multi-task”, that is, to perform several comparatively complex actions at the same time. However, as the available driver attention percentage falls, the system can make dynamic adjustments to selectively remove certain notifications from availability by adjusting the required attention level value associated with those notifications. Thus, if during times of low driver attention availability, the notification manager might selectively prune out complex social media interaction notifications while retaining incoming phone call notifications, even though both social media and phone call notifications might have originally had the same required attention level assigned. The notification manager thus can dynamically adjust the required attention levels for particular notifications based on the collective situation as it exists at that time.

Applications do not necessarily have to define their own attention level, but if desired they can be provided with a human machine interface (HMI) “identification record” to control the interaction level. The identification record is provided by the application maker or by a third party and stores the required interaction level for the main interaction classes, i.e., audio output, audio input, console screen output, touch screen input, steering wheel input, number of operations per second, number of total operations, and so forth. These data help match the application requirements to a more elaborate metric of “attention level.” In one preferred form, the “attention level” is a mix of cognitive load, motor load, and sensorial load, without distinguishing among the three. For instance, if the noise level is high, a user will not likely want to use an application that requires a lot of audio in its interface, but the user may still be available for other tasks.

Privacy can be a metric influencing the priority of an application in the queue. If the user is with other people in the vehicle, he or she will be less likely to want a private email, or social media chat pushed to the display screen.

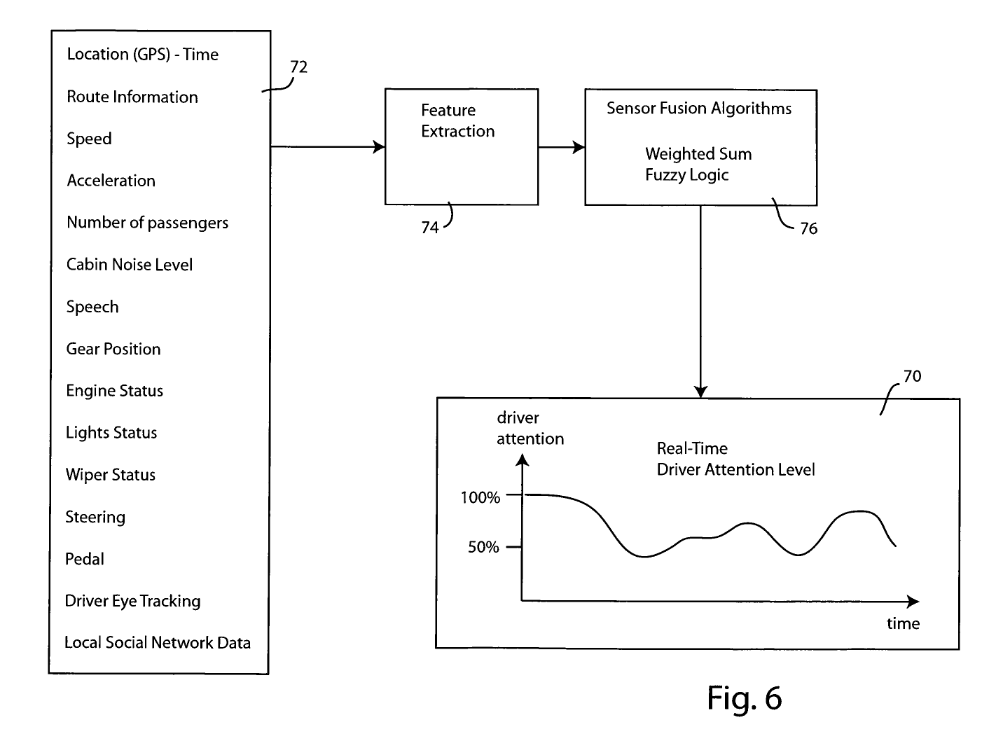

The driver attention metric of a preferred embodiment uses sensor fusion to extract data from a plurality of diverse sources. The sensor fusion technique is illustrated in FIG. 6. FIG. 6 depicts at 72 a plurality of diverse environmental and driving context condition sensors from which a driver attention metric is calculated. The list depicted at 72 in FIG. 6 is intended to be merely exemplary. Other sources of data are also possible. Because these data are from diverse sources, the system first performs feature extraction at 74 to convert the data from disparate sources into a common format. This is accomplished by extracting, and digitizing if necessary, values from the raw data feeds, storing those in memory 34 (FIG. 2) and in operating upon the stored data using an array of sensor fusion algorithms, which may implement weighted sums and/or fuzzy logic to arrive at a driver attention metric as a function of time.

In the embodiment illustrated in FIG. 6, sensor fusion is implemented as follows.

Time: One of the factors used to tie together or fuse the various data sources together is time. The notification and control apparatus derives a timestamp value from an available source of local time, such as cellular telephone data, GPS navigation system, internet time and date data feed, RF time beacon, or the like. The timestamp is associated with each of the data sources, so that all sources can be time-synchronized during data fusion.

Location (GPS): For vehicles that have location data available, such as vehicles that have a navigation system, the real time vehicle location information is captured and stored in memory 34. Location information may also be derived by triangulation upon nearby cell tower locations and other such sources. In addition, many vehicle navigation systems have inertial sensors that perform dead reckoning to define vehicle location information obtained from GPS systems. Regardless of what technique is used to obtain vehicle location information, feature extraction based on vehicle location can be used to obtain real time traffic congestion information (from XM satellite data feeds). Alternatively, where real time traffic data is not available, vehicle location can be used to access a database of historical congestion information obtained via internet feed or stored locally. Feature extraction using the vehicle location information can also be used to obtain real time weather information via XM satellite and/or internet data feeds.

Route Information: Vehicles equipped with navigation systems have the ability to plot a route from the current vehicle position to a desired end point. Feature extraction upon this route information can provide the notification manager with additional location data, corresponding to locations that are expected to be traversed in the near future. Real time traffic information and weather information from these future locations may additionally be obtained, stored in memory 34 and used as a factor in determining driver attention level. In this regard, information about upcoming traffic and weather conditions may be used by the sensor fusion algorithms to integrate or average the driver attention metric and thereby smooth out rapid fluctuations. In this regard, if the instantaneous available driver attention is high but, based on upcoming conditions, is expected to drop precipitously, the system can adjust required attention levels so that available notifications (tasks and messages) do not fluctuate on and off so rapidly as to connote system malfunction.

Speed and Acceleration: Vehicle speed and acceleration are factors that may be used by the vehicle navigation system to perform dead reckoning (inertial guidance). These values are also, themselves, relevant to driver attention metric. Depending on the vehicle location and route information, the vehicle speed within a predetermined speed limits are an indication whether driving conditions are easy or difficult. For example, when the vehicle is proceeding within normal speed limits upon a freeway in Wyoming, feature extraction would generate a value indicating that available driver attention is high, with a high degree of probability. Driving within normal speed limits on a freeway in Los Angeles would generate a lower attention level metric. Vehicle speed substantially greater than average or expected speed limits would generate a lower available driver attention value to account for the possibility that the driver needs to apply extra attention to driving. Acceleration (or deceleration) is also used an indicator that the driver attention level may be in the process of changing, perhaps rapidly so. Feature extraction uses the acceleration (or deceleration) to reduce the available driver attention value.

Number of Passengers: Many vehicles today are equipped with sensors, such as sensors located in the seats, to detect the presence of occupants. Data from these sensors is extracted to determine the number of passengers in the vehicle. Feature extraction treats the number of passengers as an indication of driver attention level. When the driver is by himself or herself, he or she likely has a higher available driver attention value than when traveling with other passengers.

Cabin Noise Level: Many vehicles today are equipped with microphones that can provide data indicative of the level of noise within the vehicle cabin. Such microphones include microphones used for hands-free voice communication and microphones used in dynamic noise reduction systems. Feature extraction performed on the cabin noise level generates a driver attention metric where a low relative cabin noise level correlates to a higher available driver attention, whereas a high cabin noise level correlates to a comparatively low driver attention.

Speech: The microphones used for hands-free voice communication may be coupled to a speech recognizer, which analyzes the conversations between driver and passengers to thereby ascertain whether the driver is engaged in conversation that would lower his or her available driver attention. In this regard, the speech recognizer may include a speaker identification system trained to discriminate the driver's speech from that of other passengers.

Gear Position and Engine Status: Modern day vehicles have electronic engine control systems that regulate many mechanical functions within the vehicle, such as automatic transmission shift points, fuel injector mixture ratios, and the like. The engine control system will typically include its own set of sensors to measure engine parameters such as RPM, engine temperature and the like. These data may also provide an indication of the type of driving currently being exhibited. In stop-and-go traffic, for example, the vehicle will undergo numerous upshifts and downshifts within a comparatively short time frame. Feature extraction upon this information is an indication of available driver attention, in that busy stop-and-go traffic leaves less available driver attention than freeway cruising.

Lights and Wiper Status: When driving at night or during heavy precipitation, the status of headlights and wipers can also provide extracted features indicative of available driver attention. Some vehicles are equipped with automatic headlights that turn on and off automatically as needed. Likewise, some vehicles have automatic wiper systems that turn on when precipitation is detected, and all vehicles provide some form of different wiper speed setting (e.g., intermittent, low, high). The data values used by the vehicle to establish these settings may be analyzed to extract feature data indicative of nighttime and/or bad weather driving conditions.

Steering and Pedal: Modern day vehicles use electrical signals to control steering and to respond to the depression of foot pedals such as the accelerator and the brake. These electrical signals can have features extracted that are indicative of the steering, braking and acceleration currently being exhibited. When the driver is steering through turns that are accompanied by braking and followed by acceleration, this can be an indication that the vehicle is in a congested area, making left and right turns, or on a curving roadway, an extreme example being Lombard Street in San Francisco. This extracted data is thus another measure of the available driver attention.

Driver Eye Tracking: There is currently technology available that uses a small driver-facing camera to track driver eye movements. This driver eye tracking data is conventionally used to detect when the driver may have become drowsy. Upon such detection, a driver alert is generated to stimulate the driver's attention. The feature extraction function of the notification manager can use this eye tracking data as an indication of driver attention level, but somewhat in the reverse of the conventional sense. Driver eye tracking data is gathered and used to develop probabilistic models of normal eye tracking behavior. That is, under normal driving conditions, a driver will naturally scan the horizon and the instrument cluster in predefined patterns that can be learned for that driver. During intense driving situations, the eye tracking data will change dramatically for many drivers and this change can be used to extract features that indicate available driver attention for other tasks is low.

Local Social Network Data: In internet connected vehicles where social network data is available via the internet, the system can use its current location (see above) to access social networks and thus identify other drivers in that vicinity. To the extent the participants in the social network have agreed to share respective information, it is possible to learn of driving conditions from information gathered by other vehicles and transmitted via the social network to the current vehicle. Thus, for example, if the driver of a nearby vehicle is having a heated conversation (argument) with vehicle passengers, or if there are other indications that the driver of that other vehicle may be intoxicated, that data can be conveyed through the social network and used as an indication that anticipated driving conditions may become degraded by the undesirable behavior of a vehicle in front of the current vehicle. Features extracted from this data would then be used to reduce the available driver attention, in anticipation that some vehicle ahead may cause a disturbance.

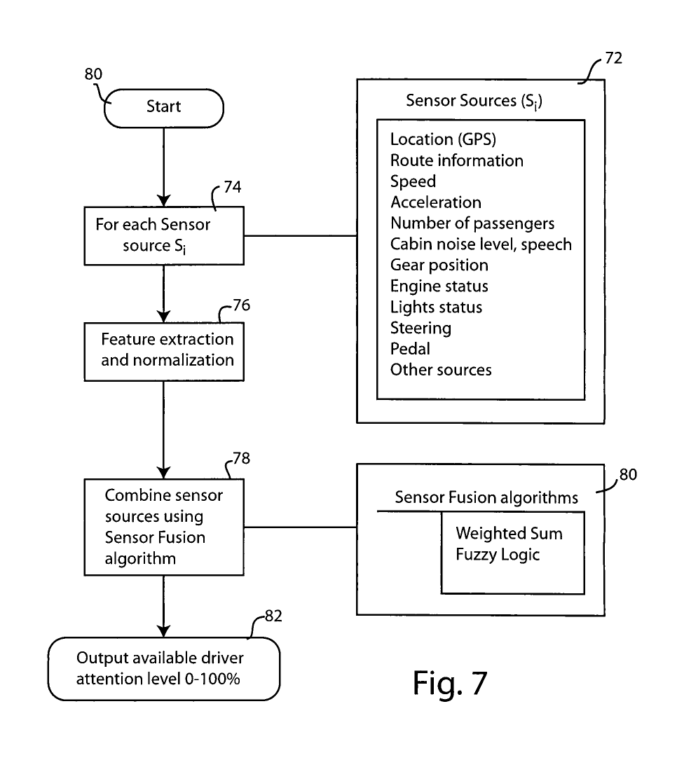

The data gathered from these and other disparate sources of driver attention-bearing information may be processed as shown in FIG. 7. The process begins at step 80 whereupon each of the sensor sources 72 is interrogated as at 74. The features, such as those discussed above, are extracted for each sensor and the values normalized as at step 76. Normalization may be performed, for example, by adopting a 0.0-1.0 scale and then projecting each of the measured values onto that scale. Moreover, if desired, some sensors may generate or have associated therewith a probability value of likelihood score indicating the degree of certainty in the value obtained. These likelihood scores may be associated with the normalized data and the normalized data is then stored in the memory 34 (FIG. 2).

Sensor fusion is then performed at 78 upon the stored data set using a predetermined fusion algorithm which may include giving different normalized values weights depending on predetermined settings and/or depending on probability values associated with those data elements. Fuzzy logic may also be used, as indicated at 80. Fuzzy logic can be used in sensor fusion and also in the estimation of driver attention level by using predefined rules. The resultant value is a numeric score representing available driver attention level, as at 82. Available driver attention level may be expressed upon a 0-100% scale, where 100% indicates that the driver can devote 100% of his or her attention to tasks other than driving. A 0% score indicates the opposite: The driver has no available attention for any tasks other than driving.

Sensor fusion may also be implemented using statistical modeling techniques. A lot of non-discrete sensory information (providing continuous values that tend to change quickly over time) may be used for such statistical modeling. The sensor inputs are used to access a trained model-based recognizer that can identify the current driving conditions and user attention levels based on recognized patterns in the data. The recognizer might be trained, for example, to discriminate between driving in a city familiar to the driver vs. driving in a city unfamiliar to the driver, by recognizing higher-level conditions (e.g., stopping at a four-way intersection) based on raw sensor data (feature vector data) representing lower-level conditions (rapid alternation between acceleration and deceleration).

To construct a statistical modeling based system, data are collected over a series of days to build a reference corpus to which manually labeled metrics are assigned. The metrics are chosen based on the sensory data the system is designed to recognize.

For example, labels may be chosen from a small set of discrete classes, such as “no attention,” “full attention,” “can tolerate audio,” “can do audio and touch and video,” and so forth. A feature vector combining readings from the pedals, steering input, stick-shift input, gaze direction, hand position on the wheel, and so forth, is constructed. This feature vector is then reduced in dimensionality using principal component analysis (PCA) or linear discriminate analysis (LDA) or other dimensionality reduction process to maximize the discriminative power. The readings can be stacked over a particular extent of time. A Gaussian Mixture Model (GMM) is then used to recognize the current attention class. If desired the system can implement two classes: a high-attention class and a low-attention class, and then use posterior probability of the high attention hypothesis as a metric.

Labels may be composed of elementary maneuvers, such as “steering right softly,” “steering right sharply,” “steering left softly,” “steering left sharply,” “braking sharply,” “accelerating sharply,” etc. These labels are then included as part of a higher elementary language block (stopping at light, starting from light, following a turn on the road, turning from one road into another, passing a car, etc.), which then build an overall language model (city driving, leaving the parking lot, highway driving, stop and go, etc.). Once the driving mode is identified, an attention metric can be associated to it based on the data collected and some heuristics.

More binary information, such as day/night, rain/shine, can be used to either load a different set of models, or simply combined with one another in a factorized probability.

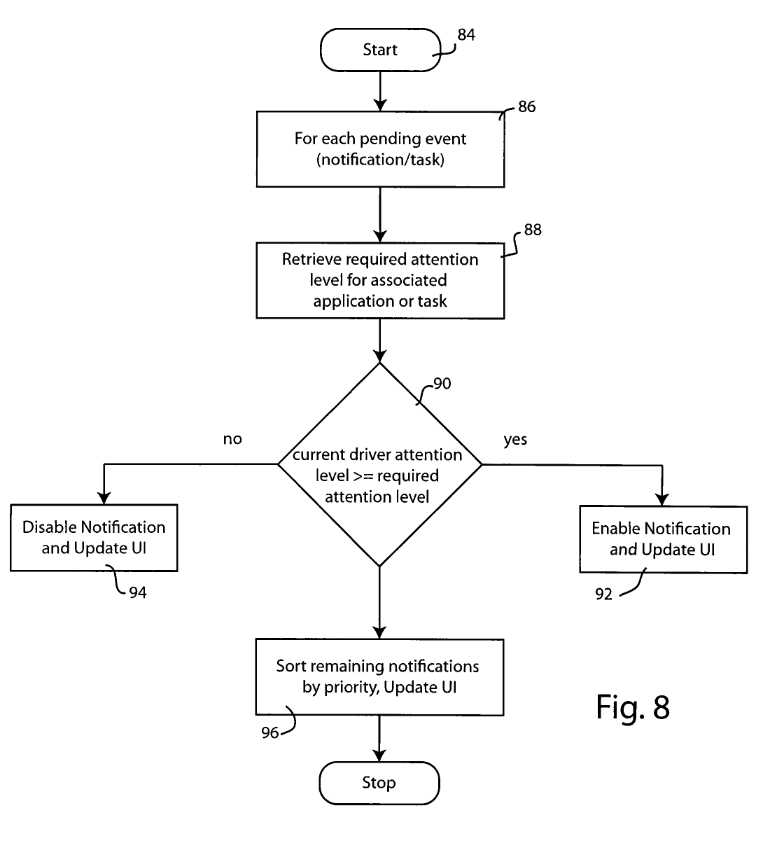

As depicted in FIG. 5, each notification in the prioritized queue has an associated required attention level. FIG. 8 shows how these associated required attention level values are used, beginning at step 84. For each pending notification (message or task), in the queue (86) the required attention level for that task is examined at 88. If the current driver attention level is greater than or equal to the required attention level (step 90), then notification for that notification is enabled at 92 and then user interface display is updated accordingly. Conversely, if the attention level is not greater than or equal to that required, the notification is disabled at 94 and the user interface is again updated accordingly. Following step 90, the remaining notifications in the queue are sorted by priority at 96 and the user interface is then again updated accordingly.

The notification manager controls display priority at several different levels. Some notifications that are universally important, such as alerting the driver to dangerous weather conditions, may be hard-coded into the notification manager's prioritization rules so that universally important messages are always presented when present. Other priorities may be user defined. For example, a user may prefer to process incoming business email messages in the morning during the commute, by having then selectively read through the vehicle infotainment system using speech synthesis. This playback of email messages would, of course, be subject to available driver attention level. Conversely, the user may prefer to defer messages from social networks during the morning commute. These user preferences may be overtly set by the user by system configuration for storage in memory 34. Alternatively, user preferences may be learned by an artificial intelligence learning mechanism that stores user usage data and correlates that data to the time of day, location of vehicle, and other measured environmental and driving context conditions obtained from sensors 72.

Priorities may also be adjusted based on the content of specific notifications. Thus incoming email messages marked “urgent” by the sender might be given higher priority in the queue.

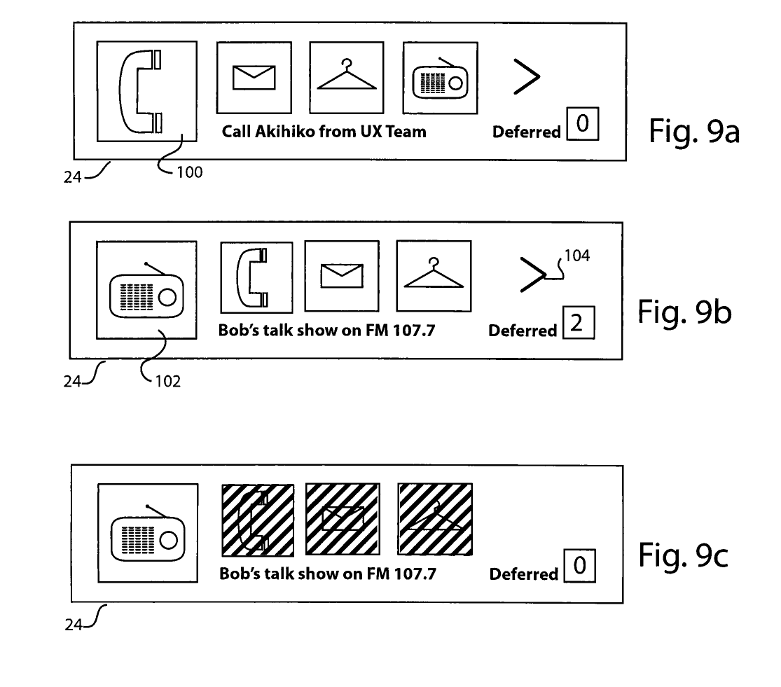

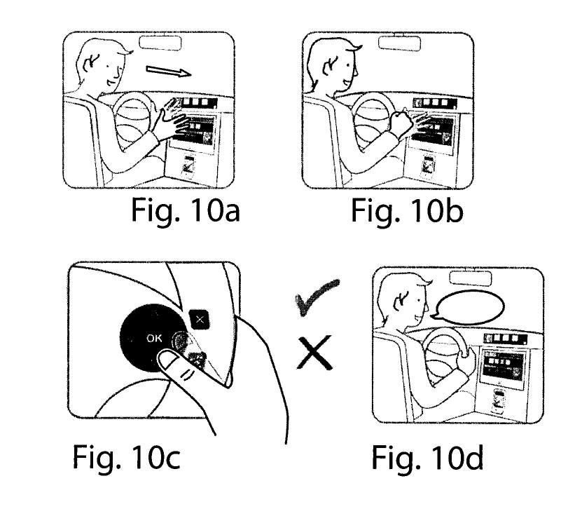

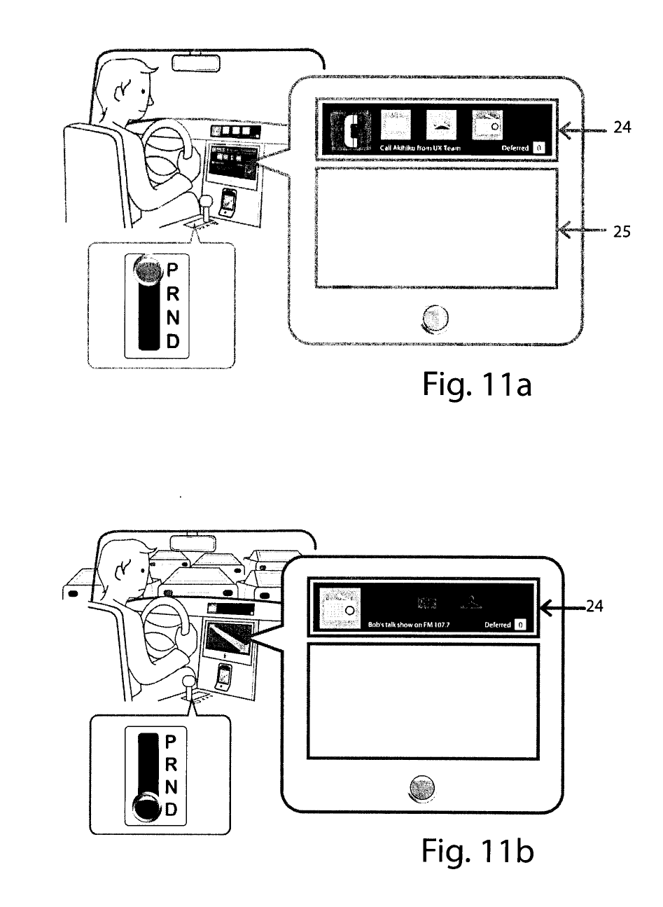

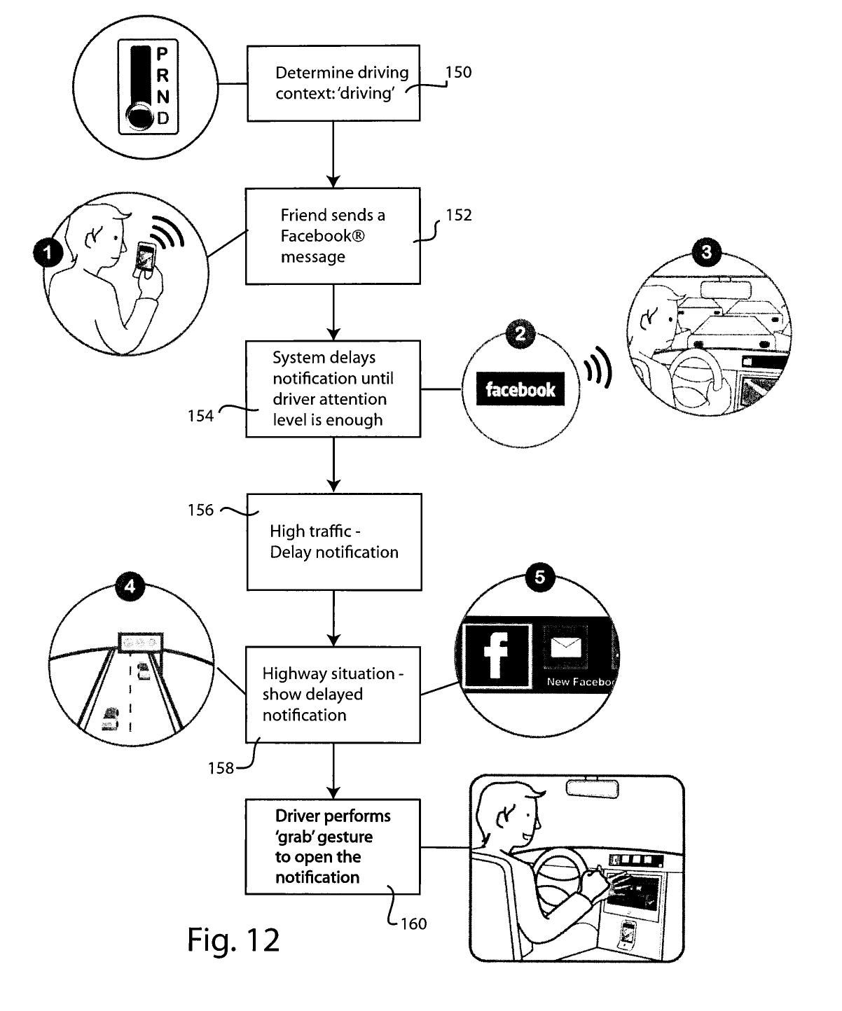

This dynamic updating of the prioritized queue ensures that the display only presents notifications and tasks that are appropriate for the current driver attention level. FIGS. 9a and 9b show different examples of this. In FIG. 9a, the telephone task is currently first in the queue. It is shown by a graphical icon 100 that is slightly larger than the remaining graphical icons in the queue which represent other items available for selection. FIG. 9b shows a different case where the radio icon 102 occupies the top priority spot. In example 9a there are no deferred notifications; example 9b shows two deferred notifications, illustrating a case where the user elected to defer two previously presented notifications and these two deferred notifications are now lower in the queue than the four icons displayed and are thus not visible. To recall these lower-in-queue icons the user interacts with the scroll icon 104 by using one of the multimodal controls. For example a swipe gesture from right to left might connote a command to scroll through the hidden icons.

In some instances certain notifications may be deferred because interaction with those notifications is not appropriate in the current driving context, such as when available driver attention is below a certain level. In such cases, icons that are not appropriate for selection are grayed-out or otherwise visually changed to indicate that they are not available for selection. This has been illustrated in FIG. 9c. If desired, displayed icons can also be color coded, based on different predefined categories, to help the user understand at a glance the nature of the available incoming notifications.

The preferred notification bar 24 is graphically animated to show re-prioritizing by a sliding motion of the graphical icons into new positions. Disabled icons change appearance by fading to a grayed-out appearance. Newly introduced icons may be caused to glow or pulsate in illumination intensity for a short duration, to attract the driver's attention in a subtle, non-distracting manner.

The notification and control apparatus opens the in-vehicle platform to a wide range of internet applications and cloud-based applications by providing a user interface that will not overwhelm the driver and a set of computer-implemented control methods that are extremely easy to use. These advantages are attributed, in part, by the dynamically prioritized queue, which takes into account instantaneous available driver attention, so that only valid notifications for the current driving attention level are presented; and in part, by an elegant simple command vocabulary that extends across multiple input mechanisms of a multi-modal control structure.

In one embodiment this simple command vocabulary consists of two commands: (1) accept (perform now) and (2) defer (save for later). These commands are expressed using the touch-responsive steering wheel-mounted push button array 42 as clicks of accept and defer buttons. Using the non-contact gesture controlled system 44, an in-air grab gesture connotes the “accept” command and an in-air left-to-right wave gesture connotes the “defer” command. Using the voice/speech recognizer controls 46 simple voiced commands “accept notification” and “defer notification” are used.

By way of further illustration, FIGS. 10a, 10b, 10c and 10d illustrate how a particular accept or defer command would be sent, and how the top notification in the queue (appearing as a larger icon on the left-most side of the notification bar 24) is selected. The user would make a left-right waving gesture (FIG. 10a) until the desired icon is featured in the left-most side of the notification bar. The user would then make an in-air grabbing gesture (FIG. 10b) to select that notification. Alternatively, the user could accomplish the same navigation and selection by operating the steering wheel-mounted controls (FIG. 10c) or by voice (FIG. 10d).

FIGS. 11a and 11b show a typical use case for the vehicular notification and control apparatus. In FIG. 11 a the vehicle is in “Park” and the available driver attention level is at 100%. In this state the vehicle is automatically connected to the driver's “cloud” profile (profile relating to the user's pre-stored online status which has access to the necessary log-in credentials to allow the system to access internet services the user has subscribed to). The vehicular notification and control apparatus thus uses the available internet connectivity to retrieve tasks and notifications that are suited to perform in the car. The driver can manipulate the controls to change the priority of tasks presented. The larger display region 25 of the display screen may be used to show additional information regarding the item selected.

FIG. 11b shows the contrasting situation where the vehicle is being operated in heavy traffic. The notification and control apparatus determines that only 15% driver attention level is available. The radio task is the only one allowed in this context. All other tasks are grayed-out and thus not available for selection.

When an incoming notification arrives, as illustrated in FIG. 12, the notification manager determines the current driving context, as at 150, by accessing real-time data from the sensors 72 (FIG. 6). In this example, a friend has sent the driver a social networking message at 152. (This is merely an example as other incoming notifications are of course also possible.) The notification manager delays presentation of this message as at 154, because it has determined that the current driver attention level is insufficient to handle this type of message. More specifically, due to high traffic congestion as at 156, the incoming social networking message is automatically deferred. Thereafter, when the traffic congestion subsides, as at 158, the queue is dynamically re-sorted and the social networking message is deemed appropriate for display on the notification bar. In this case, the incoming message is deemed to have the highest priority, compared with other queued notifications and it is presented for selection at the top of the queue (left-most position in notification bar). The driver performs a “grab” gesture as at 160 to open the social networking message.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicular notification and control apparatus comprising:
a display disposed within the vehicle;
a control mechanism disposed within the vehicle;
at least one processor coupled to the control mechanism and the display, said at least one processor having an associated data storage memory and being programmed to receive and store incoming notifications in said storage memory;
said at least one processor being programmed to implement a notification manager that sorts said stored incoming notifications into a prioritized queue;
a plurality of sensors that each respond to different environmental or driving context conditions, said plurality of sensors being coupled to a sensor fusion mechanism administered by said at least one processor to produce a driver attention metric;
said at least one processor being programmed to supply visual notifications to said display in a display order based on said prioritized queue and where the content of displayed notifications is further regulated by said driver attention metric.

2. The apparatus of claim 1 wherein the notification manager uses the driver attention metric to dynamically alter the sort order of the prioritized queue.

3. The apparatus of claim 1 wherein the notification manager is coupled to the control mechanism and dynamically alters the sort order of the prioritized queue based on user input via the control mechanism.

4. The apparatus of claim 1 wherein the plurality of sensors respond to environmental or driving context conditions selected from the group consisting of location, route information, speed, acceleration, number of passengers, vehicle cabin noise level, speech within vehicle cabin, gear position, engine status, headlight status, steering, and pedal position.

5. The apparatus of claim 1 wherein the plurality of sensors includes at least one sensor monitoring conditions of neighboring drivers.

6. The apparatus of claim 1 wherein the plurality of sensors includes at least one sensor monitoring conditions of neighboring drivers extracting data from a wireless computer network.

7. The apparatus of claim 1 wherein the plurality of sensors includes at least one sensor monitoring conditions of neighboring drivers extracting data from a social network.

8. The apparatus of claim 1 wherein said control mechanism is a multimodal control system that includes both touch-responsive control and non-touch responsive control.

9. The apparatus of claim 1 wherein said control mechanism employs a non-contact gesture control that senses gestural inputs by sensing energy reflected from a vehicle occupant's body.

10. The apparatus of claim 1 wherein said control mechanism employs a speech recognizer.

11. The apparatus of claim 1 wherein said control mechanism employs a touch pad gesture sensor.

12. The apparatus of claim 1 wherein said at least one processor is coupled to control an infotainment system located within the vehicle.
